(19) United States
(12) Patent Application Publication
(10) Pub. No.: US 2005/0136327 A1
(43) Pub. Date: Jun. 23, 2005

(54) Nonaqueous electrolyte secondary battery

(75) Inventors: Masahide Miyake, Kobe-shi (JP); Hideyuki Koga, Kobe-shi (JP); Masaharu Itaya, Kobe-shi (JP); Kazunori Donoue, Kobe-shi (JP); Masahisa Fujimoto, Osaka (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/999,997

(22) Filed: Dec. 1, 2004

(30) Foreign Application Priority Data
Dec. 4, 2003 (JP) 2003-405836

(51) Int. Cl. H01M 4/58; H01M 10/40

(52) U.S. Cl. 429/218.1; 429/326; 429/329; 429/231.95; 429/231.4

(57) ABSTRACT

A positive electrode has a positive-electrode active material obtained from a mixture of elemental sulfur, a conductive agent and a binder. A negative electrode is composed of a carbon material such as graphite, lithium alloy, or the like that can store lithium and release it. A nonaqueous electrolyte contains a first solvent composed of at least one compound selected from the group consisting of cyclic ethers and chain ethers, and a second solvent composed of a room temperature molten salt having a melting point not higher than 60° C. in a volume ratio in the range of 0.1:99.9 to 40:60, and also contains saturated lithium polysulfide.

### BACKGROUND OF THE INVENTION

1. Field of the Invention

The present invention relates to a nonaqueous electrolyte secondary battery comprising a negative electrode, positive electrode, and nonaqueous electrolyte.

2. Description of the Background Art

Nonaqueous electrolyte secondary batteries are used today as secondary batteries having high energy densities. A nonaqueous electrolyte secondary battery employing a nonaqueous electrolyte is charged and discharged by the transport of lithium ions between positive and negative electrodes.

Such a nonaqueous electrolyte secondary battery typically employs, as a positive electrode, a lithium transition metal mixed oxide such as LiCoO₂; as a negative electrode, a carbon material such as lithium metal, a lithium alloy, or a carbon material that can store lithium and release it; and as an electrolyte, an organic solvent such as ethylene carbonate or diethyl carbonate in which an electrolyte composed of a lithium salt such as LiBF₄ or LIPF₆ is dissolved.

These nonaqueous electrolyte secondary batteries have recently been used as power sources for a variety of mobile equipment, and therefore, a need exists for nonaqueous electrolyte secondary batteries with higher energy densities.

However, lithium transition metal mixed oxides such as LiCoO₂, employed for the positive electrodes in conventional nonaqueous electrolyte secondary batteries, are large in weight with small numbers of reaction electrons. This makes it difficult to sufficiently increase capacity per unit weight.

It is thus essential to develop positive-electrode materials which offer high capacities with high energy densities. Studies have recently been made using elemental sulfur for positive-electrode materials. Elemental sulfur, which has a theoretical capacity as large as 1675 mAh/g, is one of the promising materials for the positive electrodes of the next-generation secondary batteries.

These studies involve examining the charge/discharge characteristics of elemental sulfur, employing ether-based nonaqueous electrolytes. While some of them have reported cases of employing polymers for nonaqueous electrolytes, the studies basically employ polymerized ether-based organic solvents, both of which provide basically similar characteristics.

For an ether-based nonaqueous electrolyte, although elemental sulfur reacts with lithium with relatively good reversibility, elemental sulfur is eluted in the nonaqueous electrolyte during discharge, and precipitated on the electrode during charge in its reaction mechanism. In this case, not all the elemental sulfur is eluted in the nonaqueous electrolyte, and the eluted sulfur ions are diffused in the nonaqueous electrolyte to be separated from the electrode. This makes the cycle performance during charge/discharge not very good, and also poses the problem of low charge/discharge efficiency. It is thus necessary to solve these problems in order for the positive electrodes composed of elemental sulfur to be practically useful.

JP 2003-123840 A proposes a lithium-sulfur battery electrolyte including a salt having organic anodic ions. The lithium-sulfur battery employing this electrolyte, however, has a disadvantage that the capacity greatly decreases during the initial several cycles.

Meanwhile, the present applicants have found that sulfur reacts reversibly at room temperature even when a room temperature molten salt is employed as a nonaqueous electrolyte, as disclosed in the WO 03/054986 pamphlet. They also found that sulfur reacts reversibly even when a room temperature molten salt mixed with an ether is employed as a nonaqueous electrolyte. However, such nonaqueous electrolytes employing room temperature molten salts cannot be said as sufficiently optimized, and therefore, further optimization of nonaqueous electrolytes has been required in order to realize nonaqueous electrolyte secondary batteries with increased performance.

### SUMMARY OF THE INVENTION

It is an object of the present invention to provide a nonaqueous electrolyte secondary battery that undergoes a reversible charge/discharge reaction while offering good cycle performance and charge/discharge efficiency, and also provides increased capacity and energy density.

A nonaqueous electrolyte secondary battery according to one aspect of the present invention comprises: a positive electrode including elemental sulfur; a negative electrode including a material that can store lithium and release it; and a nonaqueous electrolyte, wherein the nonaqueous electrolyte contains a first solvent composed of at least one compound selected from the group consisting of cyclic ethers and chain ethers and a second solvent composed of a room temperature molten salt having a melting point not higher than 60° C. in a volume ratio in the range of 0.1:99.9 to 40:60, and also contains saturated lithium polysulfide.

The nonaqueous electrolyte secondary battery, in which the nonaqueous electrolyte contains the first and second solvents in a volume ratio in the range of 0.1:99.9 to 40:60 and also contains the saturated lithium ploysulfide, undergoes a reversible charge/discharge reaction, while offering good cycle performance and charge/discharge efficiency. This allows the capacity and energy density of the nonaqueous electrolyte secondary battery to be increased.

Note that the high viscosity of a room temperature molten salt makes it difficult to impregnate into the electrode; however, adding a cyclic ether or chain ether into the room temperature molten salt decreases the viscosity, thereby facilitating the impregnation of the electrode with the nonaqueous electrolyte.

Use of an ether-based nonaqueous electrolyte results in a reaction mechanism in which elemental sulfur is eluted into the nonaqueous electrolyte during discharge, and precipitated on the electrode during charge. The cycle performance during charge/discharge is accordingly not very good.

In addition, when mixing the first solvent composed of a cyclic ether or chain ether and the second solvent composed of a room temperature molten salt having a melting point not higher than 60° C., too large a ratio of the first solvent makes the properties of the nonaqueous electrolyte close to the properties of an ether-based nonaqueous electrolyte containing 100% ether. This degrades the cycle performance or lowers the charge/discharge efficiency when elemental sulfur is charged/discharged.

If, on the other hand, the nonaqueous electrolyte does not contain the first solvent or contains too small a ratio of the first solvent, the cycle performance and charge/discharge efficiency are good when elemental sulfur is charged/discharged, while the electrode is poorly impregnated with the nonaqueous electrolyte. This results in decreased availability of elemental sulfur.

When, on the other hand, the nonaqueous electrolyte contains the first solvent and second solvent in a volume ratio in the range of 0.1:99.9 to 40:60, the cycle performance and charge/discharge efficiency are improved with a higher availability of sulfur.

Moreover, if lithium polysulfide is not dissolved in the nonaqueous electrolyte, elemental sulfur that has turned into polysulfide when charged is dissolved from the electrode and diffuses into the electrolyte. Polysulfide ions diffused distant from the electrode cannot become involved in the discharge reaction anymore, which decreases the charge/discharge efficiency and cycle performance.

In contrast, when lithium polysulfide is dissolved to saturation in the nonaqueous electrolyte beforehand, polysulfide ions (Sₓ²⁻) such as S₈²⁻, S₆²⁻, S₄²⁻, S₂²⁻, or S²⁻ are present in the nonaqueous electrolyte with the lithium polysulfide (Li₂Sₓ) (1≦x≦8) being dissolved therein. In this case, the diffusion of the polysulfide ions dissolved from the electrode is suppressed, and the polysulfide ions are uniformly dispersed in the nonaqueous electrolyte. Moreover, the polysulfide ions near the electrode can be involved in the discharge reaction, which improves the charge/discharge efficiency and cycle performance.

It is preferable that the volume ratio of the first solvent to the second solvent is in the range of 0.1:99.9 to 30:70. This further increases the cycle performance and charge/discharge efficiency, while further increasing the availability of sulfur. It is more preferable that the volume ratio of the first solvent to the second solvent is in the range of 0.1:99.9 to 25:75. This even further increases the cycle performance and charge/discharge efficiency, while even further increasing the availability of sulfur.

It is still more preferable that the volume ratio of the first solvent to the second solvent is approximately 20:80. This still further increases the cycle performance and charge/discharge efficiency, while still further increasing the availability of sulfur.

It is necessary for the room temperature molten salt used as the second solvent to remain liquid in a broad range of temperatures: in general, a room temperature molten salt that stays liquid in the range of −20 to 60° C. can be used as the second solvent for the nonaqueous electrolyte.

The room temperature molten salt having a melting point not higher than 60° C. is a liquid composed of ions only, which is free of vapor pressures and flame-retardant. It is also desired that the conductivity of the room temperature molten salt be not less than 10⁻⁴ S/cm.

Mixing the first solvent composed of a cyclic ether or chain ether and the second solvent composed of the room temperature molten salt having a melting point not higher than 60° C., as described above, decreases the possibility of combustion, compared with the nonaqueous electrolyte containing 100% ether.

It is preferable that the room temperature molten salt having a melting point not higher than 60° C. includes quaternary ammonium salts having melting points not higher than 60° C. It is known that quaternary ammonium salts are superior in resistance to reduction than other room temperature molten salts such as imidazolium salts or pyrazolium salts, and do not react with lithium metal. Other room temperature molten salts, such as imidazolium salts or pyrazolium salts, are lower in resistance to reduction, thus easily reacting with lithium metal.

Use of a quaternary ammonium salt as the room temperature molten salt therefore provides better cycle performance and charge/discharge efficiency.

The second solvent may include trimethylpropylammonium bis(trifluoromethylsulfonyl)imide. This sufficiently improves the cycle performance and charge/discharge efficiency.

The first solvent may include 4-methyl-1,3-dioxolane. This sufficiently improves the cycle performance and charge/discharge efficiency.

The positive electrode may further contain a conductive agent. Since elemental sulfur is not high in conductivity, mixing a conductive agent into the positive electrode can improve the conductivity of the positive electrode.

Examples of such conductive agent may include conductive carbon materials. Note that when adding a conductive carbon material, a small amount cannot sufficiently improve the conductivity of the positive electrode, whereas too large an amount decreases the ratio of elemental sulfur in the positive electrode, and fails to achieve high capacity. Therefore, the amount of a carbon material should be adjusted in the range of 5% to 84 wt % for the whole; preferably in the range of 5% to 54 wt %; more preferably in the range of 5% to 20 wt %.

The material that can store lithium and release it may include at least one selected from the group consisting of lithium metal, lithium alloys, silicon, and carbon. In this case, the nonaqueous electrolyte secondary battery is charged/discharged with lithium easily being stored in and released from the negative electrode.

The nonaqueous electrolyte secondary battery according to the invention, in which the nonaqueous electrolyte contains the first and second solvents in a volume ratio in the range of 0.1:99.9 to 40:60, and also contains the saturated lithium polysulfide, undergoes a reversible charge/discharge reaction, while offering good cycle performance and charge/discharge efficiency. This allows the capacity and energy density of the nonaqueous electrolyte secondary battery to be increased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic explanatory diagram of a test cell prepared in inventive examples 1, 2, 3, or 4, or in comparative examples 1, 2, 3, 4, or 5;

FIG. 2 is a graph showing the initial charge/discharge characteristics of the test cell in the inventive example 1;

FIG. 3 is a graph showing the specific charge/discharge capacity and charge/discharge efficiency for each cycle of the test cell in the inventive example 1 when it is repeatedly charged and discharged;

FIG. 4 is a graph showing the initial charge/discharge characteristics of the test cell in the inventive example 2;

FIG. 5 is a graph showing the specific charge/discharge capacity and charge/discharge efficiency for each cycle of the test cell in the inventive example 2 when it is repeatedly charged and discharged;

FIG. 6 is a graph showing the initial charge/discharge characteristics of the test cell in the inventive example 3;

FIG. 7 is a graph showing the specific charge/discharge capacity and charge/discharge efficiency for each cycle of the test cell in the inventive example 3 when it is repeatedly charged and discharged;

FIG. 8 is a graph showing the initial charge/discharge characteristics of the test cell in the inventive example 4;

FIG. 9 is a graph showing the specific charge/discharge capacity and charge/discharge efficiency for each cycle of the test cell in the inventive example 4 when it is repeatedly charged and discharged;

FIG. 10 is a graph showing the initial charge/discharge characteristics of the test cell in the comparative example 1;

FIG. 11 is a graph showing the specific charge/discharge capacity and charge/discharge efficiency for each cycle of the test cell in the comparative example 1 when it is repeatedly charged and discharged;

FIG. 12 is a graph showing the initial charge/discharge characteristics of the test cell in the comparative example 2;

FIG. 13 is a graph showing the specific charge/discharge capacity and charge/discharge efficiency for each cycle of the test cell in the comparative example 2 when it is repeatedly charged and discharged;

FIG. 14 is a graph showing the initial charge/discharge characteristics of the test cell in the comparative example 3;

FIG. 15 is a graph showing the specific charge/discharge capacity and charge/discharge efficiency for each cycle of the test cell in the comparative example 3 when it is repeatedly charged and discharged;

FIG. 16 is a graph showing the initial charge/discharge characteristics of the test cell in the comparative example 4;

FIG. 17 is a graph showing the specific charge/discharge capacity and charge/discharge efficiency for each cycle of the test cell in the comparative example 4 when it is repeatedly charged and discharged;

FIG. 18 is a graph showing the initial charge/discharge characteristics of the test cell in the comparative example 5; and

FIG. 19 is a graph showing the specific charge/discharge capacity and charge/discharge efficiency for each cycle of the test cell in the comparative example 5 when it is repeatedly charged and discharged.

### DESCRIPTION OF THE PREFERRED EMBODIMENTS

A nonaqueous electrolyte secondary battery according to an embodiment of the present invention will be described.

The nonaqueous electrolyte secondary battery according to the embodiment comprises a negative electrode, a positive electrode, and a nonaqueous electrolyte.

The positive electrode has a positive-electrode active material obtained from a mixture of elemental sulfur, a conductive agent and a binder. Examples of the conductive agent may include a conductive carbon material. Note that the addition of a small amount of conductive carbon material cannot sufficiently improve the conductivity of the positive electrode, whereas the addition of an excessive amount decreases the ratio of elemental sulfur in the positive electrode, and fails to achieve a high capacity. Thus, it is preferable that the amount of carbon material is in the 5% to 84 wt % range for the whole positive-electrode active material, more preferably in the 5% to 54 wt % range, even more preferably in the 5% to 20 wt % range.

It is also possible to employ foam aluminum, foam nickel, or the like as the current collector of the positive electrode for increased conductivity.

Examples of the negative electrode may include a carbon material such as graphite or a lithium alloy that can store lithium (Li) and release it.

In order to achieve a nonaqueous electrolyte secondary battery with increased energy density, it is desirable to employ silicon having large capacity as the negative electrode. It is particularly preferable that the current collector is composed of a negative electrode made of silicon using a surface-roughened foil, or made of silicon having a columnar structure, or made of silicon in which copper (Cu) is dispersed, or a negative electrode having at least one of these characteristics, as proposed in JP 2001-266851 A and JP 2002-83594 A (corresponding to WO01/029912).

Note that the nonaqueous electrolyte secondary battery according to this embodiment maintains lithium involving the charge/discharge reaction in either of the above-mentioned positive or negative electrode.

The nonaqueous electrolyte for use in the embodiment contains a first solvent composed of at least one compound selected from the group consisting of cyclic ethers and chain ethers and a second solvent composed of a room temperature molten salt having a melting point of not higher than 60° C. in a volume ratio in the range of 0.1:99.9 to 40:60, and also contains saturated lithium polysulfide.

Examples of cyclic ethers may include 1,3-dioxolane, 2-methyl-1,3-dioxolane, 4-methyl-1,3-dioxolane, tetrahydrofuran, 2-methyl tetrahydrofuran, propylene oxide, 1,2-butylene oxide, 1,4-dioxiane, 1,3,5-trioxane, furan, 2-methy furan, 1,8-cineole, and crown ether.

Examples of chain ethers may include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, tetraethylene glycol dimethyl ether, and polyethylene glycol dimethyl ether.

The first solvent may be composed of one or more compounds selected from the above-mentioned cyclic ethers and chain ethers.

It is preferable to employ a quaternary ammonium salt having a melting point not higher than 60° C. as the room temperature molten salt having a melting point not higher than 60° C.

Examples of quaternary ammonium salts may include
trimethylpropylammonium bis(trifluoromethylsulfonyl)imide((CH₃)₃N⁺(C₃H₇)N⁻(SO₂CF₃)₂),
trimethyloctylammonium bis(trifluoromethylsulfonyl)imide((CH₃)₃N⁺(C₈H₁₇)N⁻(SO₂CF₃)₂),
trimethylallylammonium bis(trifluoromethylsulfonyl)imide((CH₃)₃N⁺(Allyl)N⁻(SO₂CF₃)₂), trimethylhexylammonium bis(trifluoromethylsulfonyl)imide((CH₃)₃N⁺(C₆H₁₃)N⁻(SO₂CF₃)₂),
methoxymethyltrimethylammonium bis(trifluoromethylsulfonyl)imide((CH₃)₃N⁺(CH₂OCH₃)N⁻(SO₂CF₃)₂), trimethylethylammonium 2,2,2-trifluoro-N-(trifluoromethylsulfonyl)acetamide((CH₃)₃N⁺(C₂H₅)(CF₃CO)N⁻(SO₂CF₃)), trimethylallylammonium 2,2,2-trifluoro-N-(trifluoromethylsulfonyl)acetamide((CH₃)₃N⁺(Allyl)(CF₃CO)N⁻(SO₂CF₃)), trimethylpropylammonium 2,2,2-trifluoro-N-(trifluoromethylsulfonyl)acetamide((CH₃)₃N⁺(C₃H₇)(CF₃CO)N⁻(SO₂CF₃)), tetraethylammonium 2,2,2-trifluoro-N-(trifluoromethylsulfonyl)acetamide((C₂H₅)₄N⁺(CF₃CO)N⁻(SO₂CF₃)), and triethylmethylammonium 2,2,2-trifluoro-N-(trifluoromethylsulfonyl)acetamide((C₂H₅)₃N⁺(CH₃)(CF₃CO)N⁻(SO₂CF₃)).

The second solvent may be composed of one or more compounds of the above-mentioned quaternary ammonium salts having melting points not higher than 60° C.

Note that other room temperature molten salts such as imidazolium salts or pyrazolium salts may also be employed as the second solvent, although they are less resistant to reduction than quaternary ammonium salts, and more likely to react with lithium metal.

It is preferable that the volume ratio of the first solvent to the second solvent is in the range of 0.1:99.9 to 30:70. This leads to further improvements in the cycle performance and charge/discharge efficiency. It is more preferable that the volume ratio is in the range of 0.1:99.9 to 25:75. This leads to even further improvements in the cycle performance and charge/discharge efficiency. It is still more preferable that the volume ratio is in the range of approximately 20:80. This leads to still further improvements in the cycle performance and charge/discharge efficiency.

For instance, it is preferable that a nonaqueous electrolyte containing 4-methyl-1,3-dioxolane and trimethylpropylammoniumbis(trifluoromethylsulfonyl)imide in a volume ratio in the range of 0.1:99.9 to 40:60 is saturated with lithium polysulfide. It is more preferable that a nonaqueous electrolyte containing 4-methyl-1,3-dioxolane and trimethylpropylammoniumbis(trifluoromethylsulfonyl)imide in a volume ratio in the range of 0.1:99.9 to 30:70 is saturated with lithium polysulfide. It is even more preferable that a nonaqueous electrolyte containing 4-methyl-1,3-dioxolane and trimethylpropylammoniumbis(trifluoromethylsulfonyl)imide in a volume ratio in the range of 20:80 is saturated with lithium polysulfide.

A lithium salt maybe added to the nonaqueous electrolyte. Lithium salts commonly used in nonaqueous electrolyte secondary batteries may be employed as the lithium salt to be added to the nonaqueous electrolyte. Such examples may include LiBF₄, LiPF₆, LiCF₃SO₃, LiC₄F₉SO₃, LiN(CF₃SO₂)₂, LiN(C₂F₅SO₂)₂, LiAsF₆, and lithium difluoro(oxalato)borate expressed in the following structural formula:

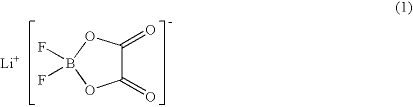

One of the above-mentioned lithium salts may be used or two or more of them may be used in combination.

The nonaqueous electrolyte secondary battery according to this embodiment with the nonaqueous electrolyte containing the first and second solvents undergoes a reversible charge/discharge reaction, while offering good cycle performance and charge/discharge efficiency. This allows the capacity and energy density of the nonaqueous electrolyte secondary battery to be increased.

### EXAMPLES

It will be made clear through Examples, that the present invention can provide nonaqueous electrolyte secondary batteries that are properly charged and discharged at room temperature, offer good cycle performance when charged or discharged, and also offer higher charge/discharge efficiencies, even when employing elemental sulfur for the positive electrodes. Note that the nonaqueous electrolyte secondary batteries according to the invention are not limited to the inventive examples shown below, and may be modified as appropriate within a scope where the gist of the invention is not altered.

### Inventive Example 1

A nonaqueous electrolyte according to the inventive example 1 was prepared as follows. 4-methyl-1,3-dioxolane and trimethylpropylammoniumbis(trifluoromethylsulfonyl)imide, a room temperature molten salt, were mixed in a volume ratio of 10:90. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. The nonaqueous electrolyte exhibited an auburn color, which is probably attributed to the polysulfide production.

The positive electrode was prepared as follows. Elemental sulfur as an active material was adjusted to be 60 wt % for the whole positive electrode, and Ketchen black as a conductive agent was adjusted to be 35 wt % for the whole positive electrode, and they were admixed by ball milling. The resultant mixture was subsequently mixed with 4 wt % styrene butadiene rubber (SBR) as a binder and 1 wt % carboxymethylcellulose (CMC) as a thickener to prepare a slurry. The slurry prepared was applied onto an electrolytic aluminum foil by a doctor blade, and then dried at 50° C. using a hotplate. The resultant material was cut into a 2 cm×2 cm size, followed by vacuum drying at 50° C. The material thus prepared was used as the positive electrode.

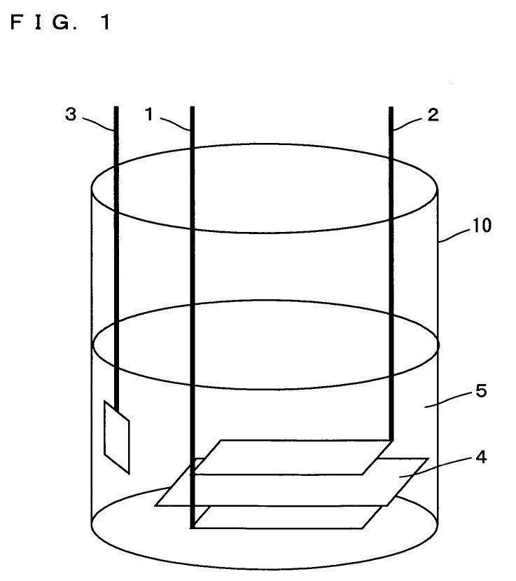

As shown in FIG. 1, a test cell according to the inventive example 1 was prepared as follows. The above nonaqueous electrolyte 5 was poured into a test cell vessel 10 under an inert atmosphere. The above positive electrode was employed as a working electrode 1, and lithium metals were employed as the negative electrode that is a counter electrode 2 and as a reference electrode 3, respectively.

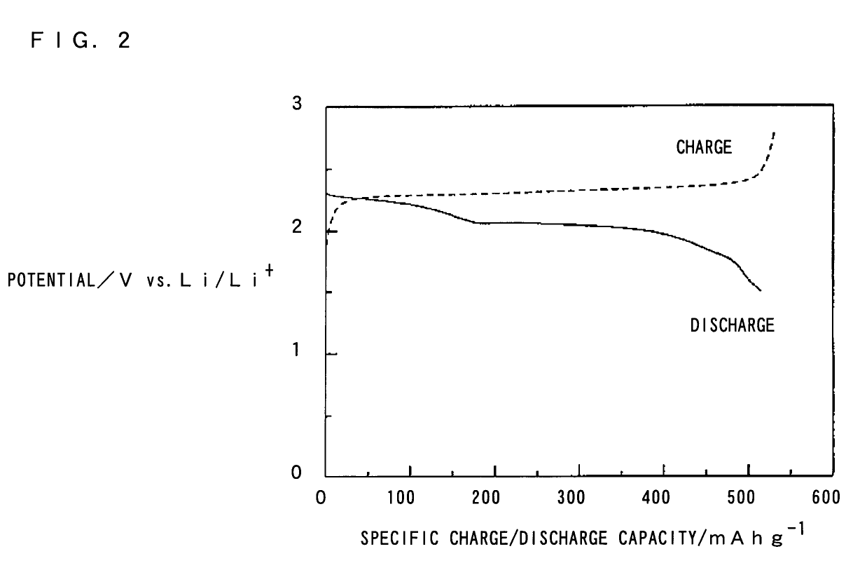

The test cell of the inventive example 1 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 2.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 515 mAh/g, and the subsequent specific charge capacity was 530 mAh/g.

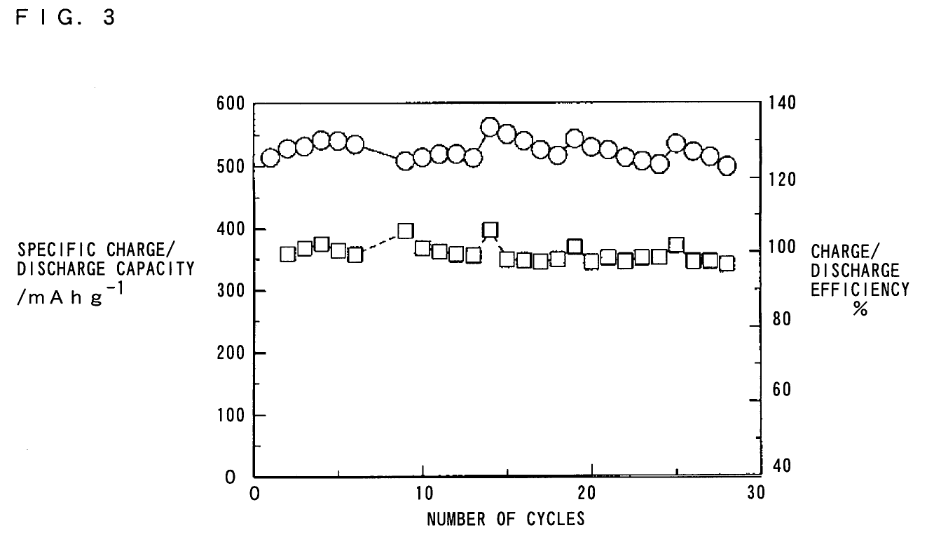

The test cell of the inventive example 1 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the equation below. FIG. 3 shows the specific discharge capacity (mAh/g) for each cycle indicated by the circle and solid line, and the charge/discharge efficiency (%) for each cycle indicated by the square and broken line.
Charge/discharge efficiency (%)=(Qb/Qa)×100

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 28^{th} cycle was 500 mAh/g, whereas the capacity maintenance factor was 97.1%. The average charge/discharge efficiency proved to be 99.5%.

### Inventive Example 2

A nonaqueous electrolyte according to the inventive example 2 was prepared as follows. 4-methyl-1,3-dioxolane and trimethylpropylammoniumbis(trifluoromethylsulfonyl)imide, a room temperature molten salt, were mixed in a volume ratio of 20:80. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the inventive example 2 was prepared similarly as in the inventive example 1.

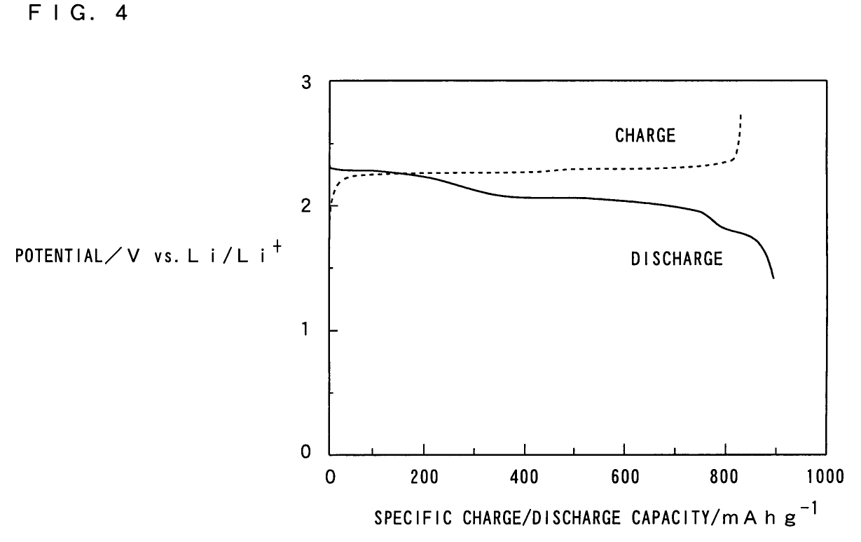

The test cell of the inventive example 2 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 4.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 890 mAh/g, and the subsequent specific charge capacity was 818 mAh/g.

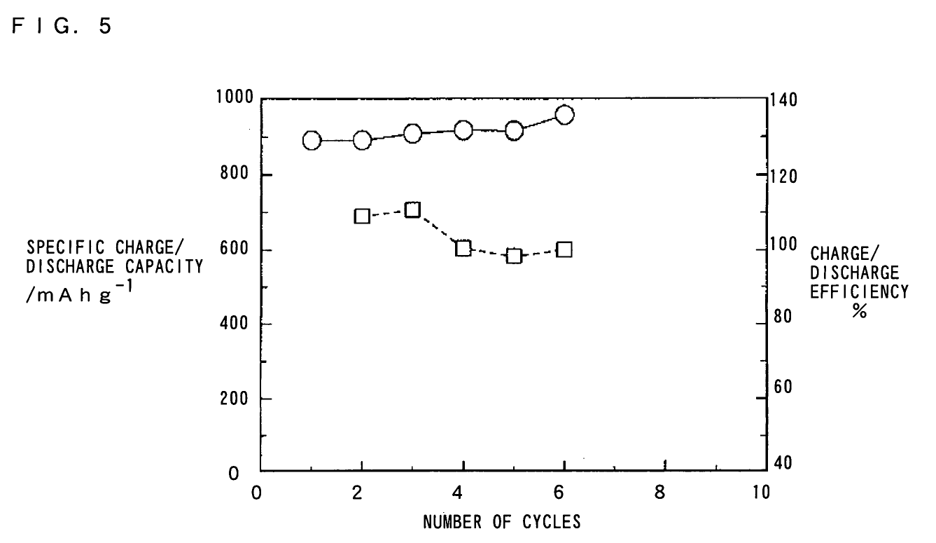

The test cell of the inventive example 2 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 5 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 6^{th} cycle was 956 mAh/g, whereas the capacity maintenance factor was 107%. The average charge/discharge efficiency proved to be 103%.

### Inventive Example 3

A nonaqueous electrolyte according to the inventive example 3 was prepared as follows. 4-methyl-1,3-dioxolane and trimethylpropylammoniumbis(trifluoromethylsulfonyl)imide, a room temperature molten salt, were mixed in a volume ratio of 30:70. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the inventive example 3 was prepared similarly as in the inventive example 1.

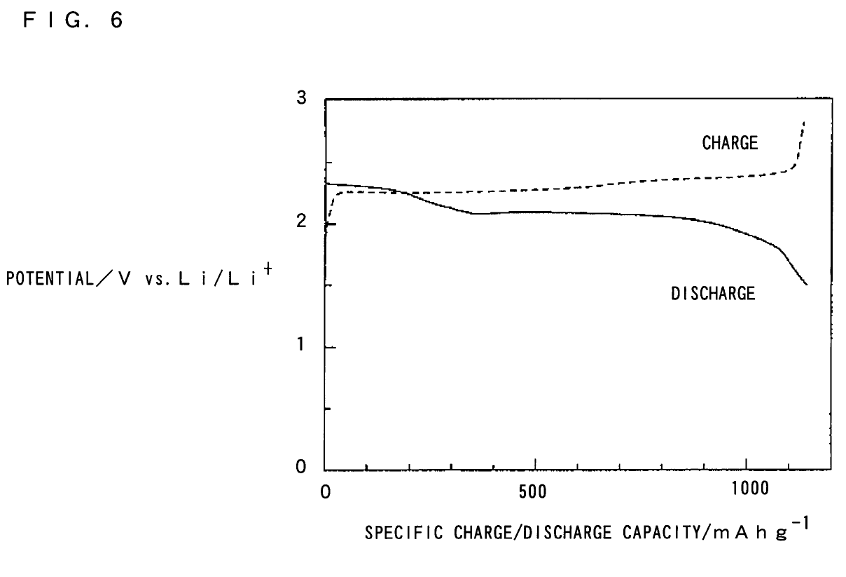

The test cell of the inventive example 3 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 6.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 1141 mAh/g, and the subsequent specific charge capacity was 1134 mAh/g.

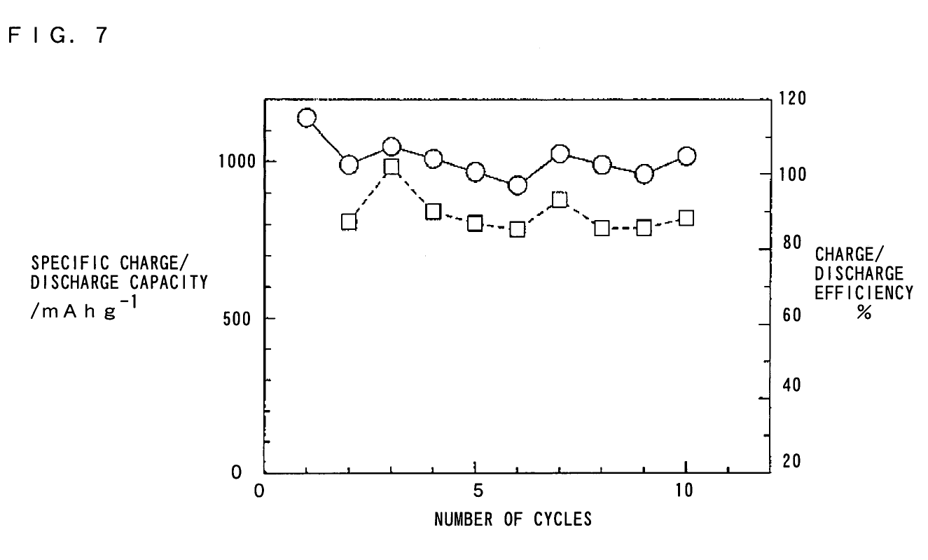

The test cell of the inventive example 3 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 7 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 10^{th} cycle was 1016 mAh/g, whereas the capacity maintenance factor was 89.0%. The average charge/discharge efficiency proved to be 89.3%.

### Inventive Example 4

A nonaqueous electrolyte according to the inventive example 4 was prepared as follows. 4-methyl-1,3-dioxolane and trimethylpropylammoniumbis(trifluoromethylsulfonyl)imide, a room temperature molten salt, were mixed in a volume ratio of 40:60. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the inventive example 4 was prepared similarly as in the inventive example 1.

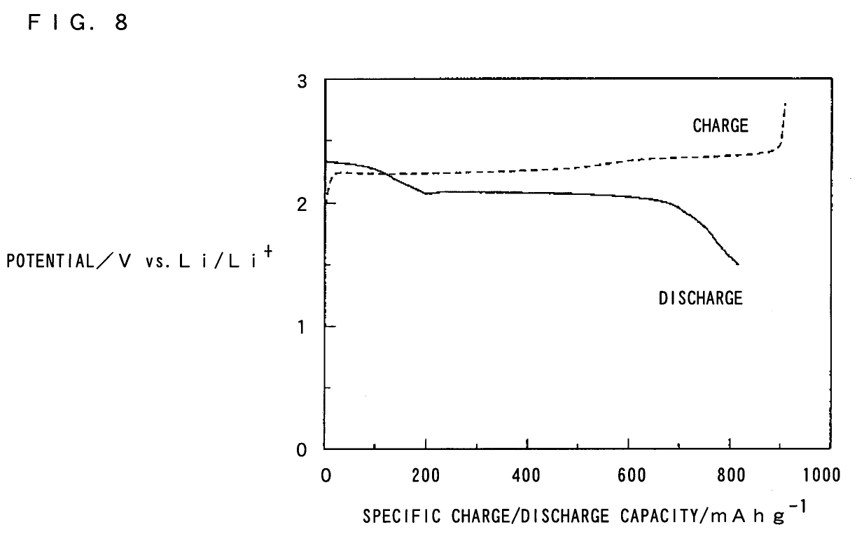

The test cell of the inventive example 4 was discharged to a discharge cutoff potential of 1.5V (vs. Li/Li⁺) at a discharge current of 0.05 mA/cm², and charged to a charge cutoff potential of2.8 V (vs. Li/Li⁺) at a charge current of 0.05 mA/cm² to examine its charge/discharge characteristics. The results are given in FIG. 8.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 816 mAh/g, and the subsequent specific charge capacity was 908 mAh/g.

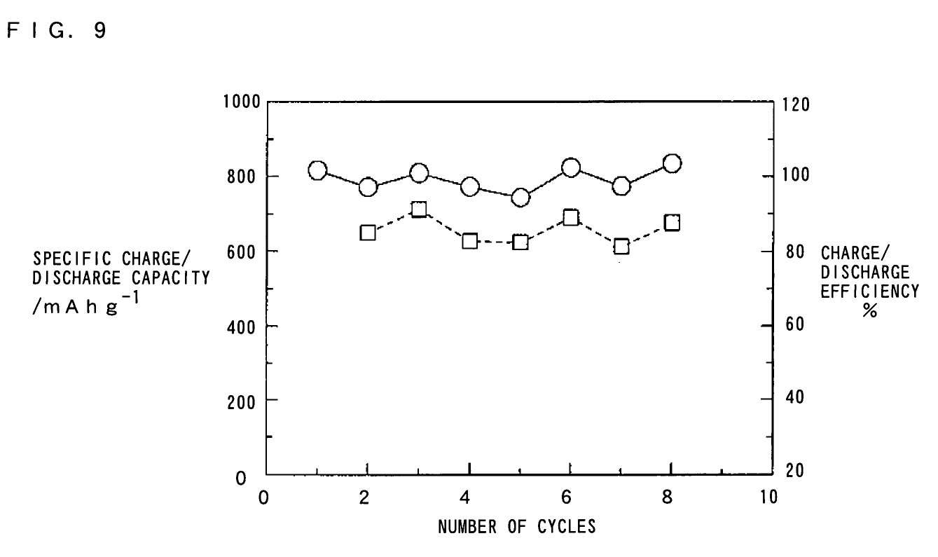

The test cell of the inventive example 4 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 9 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 8^{th} cycle was 834 mAh/g, whereas the capacity maintenance factor was 102%. The average charge/discharge efficiency proved to be 85.6%.

### Comparative Example 1

A nonaqueous electrolyte according to the comparative example 1 was prepared as follows. 4-methyl-1,3-dioxolane was added to lithium bis(trifluoromethylsulfonyl)imide to give a concentration of 1 mol/l, and the resultant mixture was employed as the nonaqueous electrolyte. Otherwise, the test cell of the comparative example 1 was prepared similarly as in the inventive example 1.

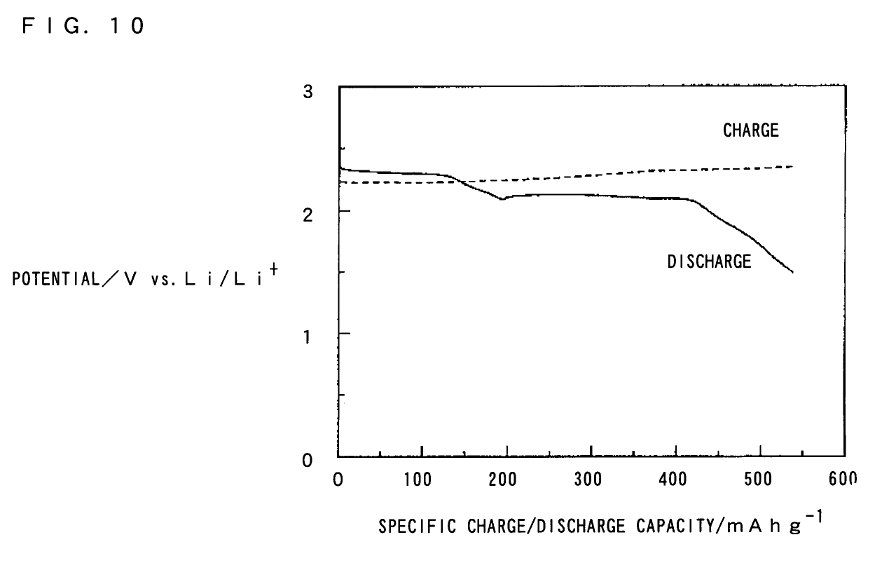

The test cell of the comparative example 1 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 10.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The result was that the initial specific discharge capacity was 538 mAh/g. After this, attempts were made to charge the cell to 2.8 V (vs. Li/Li⁺), but it did not reach the charge cutoff potential, and therefore terminated at the same capacity as that of the initial specific discharge capacity. One possible reason why the cell did not reach the charge cutoff potential when charged is that the self-discharge reaction occurred along with the charge reaction.

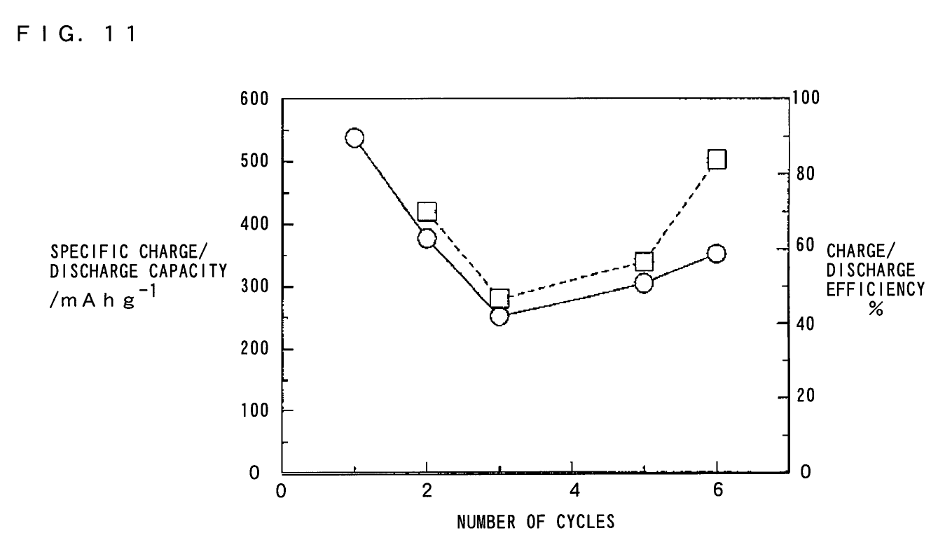

The test cell of the comparative example 1 was repeatedly discharged to the discharge cutoff potential of 1.5V (vs. Li/Li⁺) at the discharge current of 0.05 mA/cm², and then charged to the same capacity as the initial specific discharge capacity, to evaluate the specific charge capacity Qa (mAh/g) and the specific discharge capacity Qb (mAh/g) for each cycle, and also determine the charge/discharge efficiency (%) for each cycle using the above equation. FIG. 11 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 6^{th} cycle was 352 mAh/g, whereas the capacity maintenance factor was 65.4%. The average charge/discharge efficiency proved to be 64.3%.

### Comparative Example 2

A nonaqueous electrolyte according to the comparative example 2 was prepared as follows. 4-methyl-1,3-dioxolane and trimethylpropylammoniumbis(trifluoromethylsulfonyl)imide, a room temperature molten salt, were mixed in a volume ratio of 80:20. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the comparative example 2 was prepared similarly as in the inventive example 1.

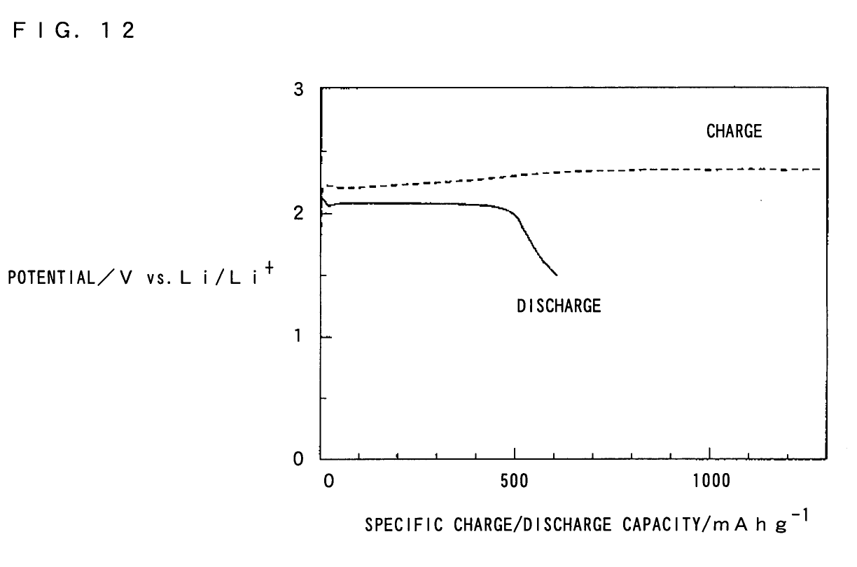

The test cell of the comparative example 2 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 12.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The result was that the initial specific discharge capacity was 605 mAh/g. After this, attempts were made to charge the cell to 2.8 V (vs. Li/Li⁺), but it did not reach the charge cutoff potential, and therefore terminated at a capacity of 1290 mAh/g. One possible reason why the cell did not reach the charge cutoff potential when charged is that the self-discharge reaction occurred along with the charge reaction.

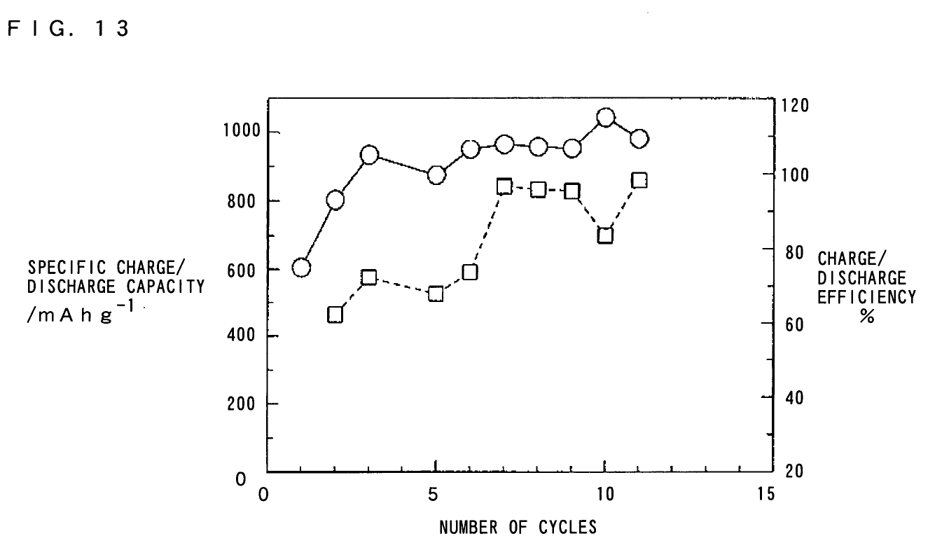

The test cell of the comparative example 2 was repeatedly discharged to the discharge cutoff potential of 1.5V (vs. Li/Li⁺) at the discharge current of 0.05 mA/cm², and then charged at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 13 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. Charges after the 2^{nd} to 6^{th} cycles, respectively, were terminated at a charge capacity of 1290 mAh/g, and charges after the 7^{th} cycle and the following cycles were terminated at a charge capacity of 1000 mAh/g. The specific discharge capacity after the 11^{th} cycle was 981 mAh/g, whereas the capacity maintenance factor was 162%. The average charge/discharge efficiency was 69.0% for the 2^{nd} to 6^{th} cycles, and 93.9% for the 7^{th} cycle and the following cycles.

The reason that the capacity maintenance factor greatly exceeded 100% is probably because self-discharging had occurred prior to the tests, considering, as can be seen from the initial discharge characteristics, that for the test cells of the inventive examples 1 to 4, discharge plateaus are observed at around 2.2 to 2.3 V (vs. Li/Li⁺), whereas for the test cell of the comparative example 2, no discharge plateau is observed at around 2.2 to 2.4 V (vs. Li/Li⁺). The reason that the charge/discharge efficiencies for the 7^{th} cycle and after that are close to 100% is probably because the charge/discharge efficiencies were increased by limiting the specific charge capacities.

### Comparative Example 3

A nonaqueous electrolyte according to the comparative example 3 was prepared as follows. 4-methyl-1,3-dioxolane and trimethylpropylammoniumbis(trifluoromethylsulfonyl)imide, a room temperature molten salt, were mixed in a volume ratio of 50:50. To the resultant mixture was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the comparative example 3 was prepared similarly as in the inventive example 1.

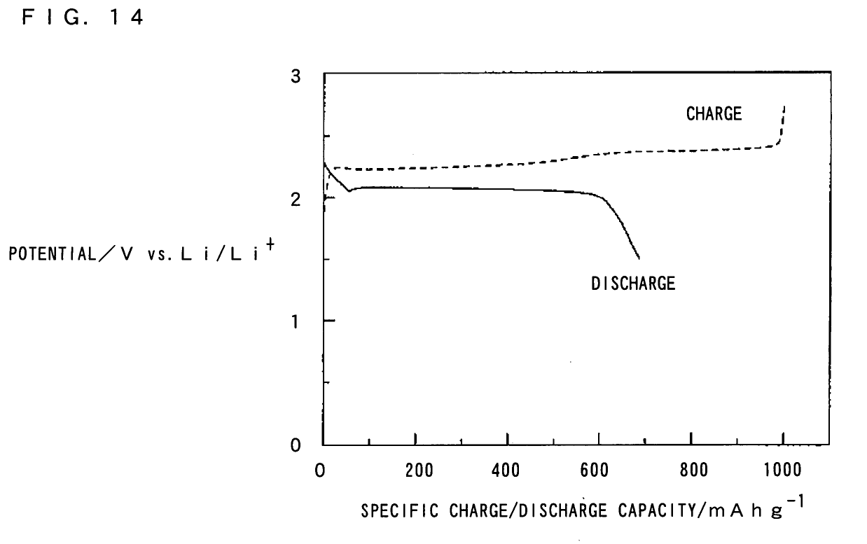

The test cell of the comparative example 3 was discharged to a discharge cutoff potential of 1.5V (vs. Li/Li⁺) at a discharge current of 0.05 mA/cm², and charged to a charge cutoff potential of2.8 V (vs. Li/Li⁺) at a charge current of 0.05 mA/cm² to examine its charge/discharge characteristics. The results are given in FIG. 14.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 686 mAh/g, and the subsequent specific charge capacity was 1000 mAh/g.

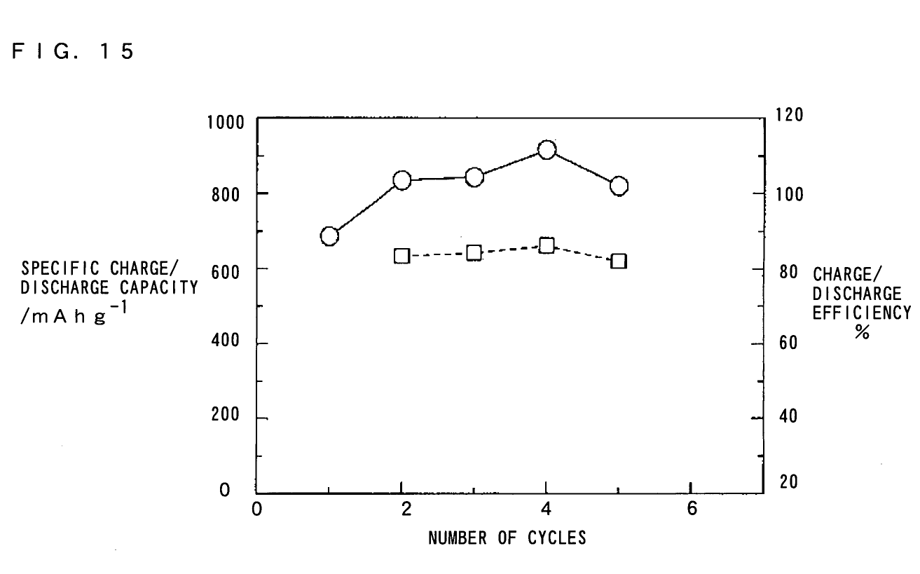

The test cell of the comparative example 3 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 15 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 5^{th} cycle was 820 mAh/g, whereas the capacity maintenance factor was 120%. The average charge/discharge efficiency proved to be 84.2%.

The reason why the capacity maintenance factor greatly exceeded 100% is probably that self-discharging had occurred prior to the tests, as with the comparative example 2. One possible reason for the poor charge/discharge efficiency of 84.2% is that self-discharging was proceeding concurrently with charging. For the test cell of the comparative example 3, charging up to 2.8 V (vs. Li/Li⁺) was possible during charge, probably because the speed of its self-discharge was slower than that of the test cell of the comparative example 2.

### Comparative Example 4

A nonaqueous electrolyte according to the comparative example 4 was prepared as follows. To trimethylpropylammonium bis(trifluoromethylsulfonyl)imide, a room temperature molten salt, was added lithium sulfide to give a concentration of 0.5 mol/l, and elemental sulfur to give a concentration of 3.5 mol/l. Then, using hot water of 60° C., the dissolution of the lithium sulfur and elemental sulfur in the resultant solution was promoted to produce polysulfide. The polysulfide saturated was employed as the nonaqueous electrolyte. Otherwise, the test cell of the comparative example 4 was prepared similarly as in the inventive example 1.

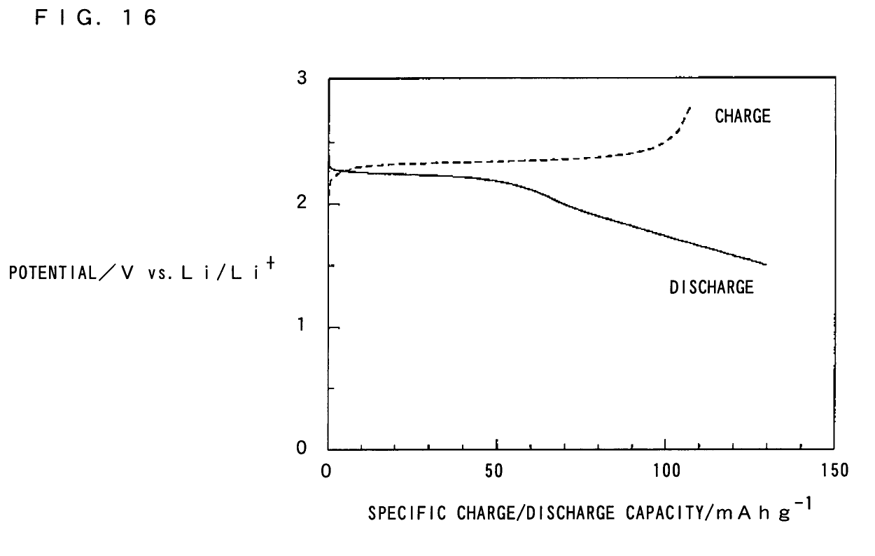

The test cell of the comparative example 4 was discharged to a discharge cutoff potential of 1.5V (vs. Li/Li⁺) at a discharge current of 0.05 mA/cm², and charged to a charge cutoff potential of2.8 V (vs. Li/Li⁺) at a charge current of 0.05 mA/cm² to examine its charge/discharge characteristics. The results are given in FIG. 16.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 130 mAh/g, and the subsequent specific charge capacity was 107 mAh/g.

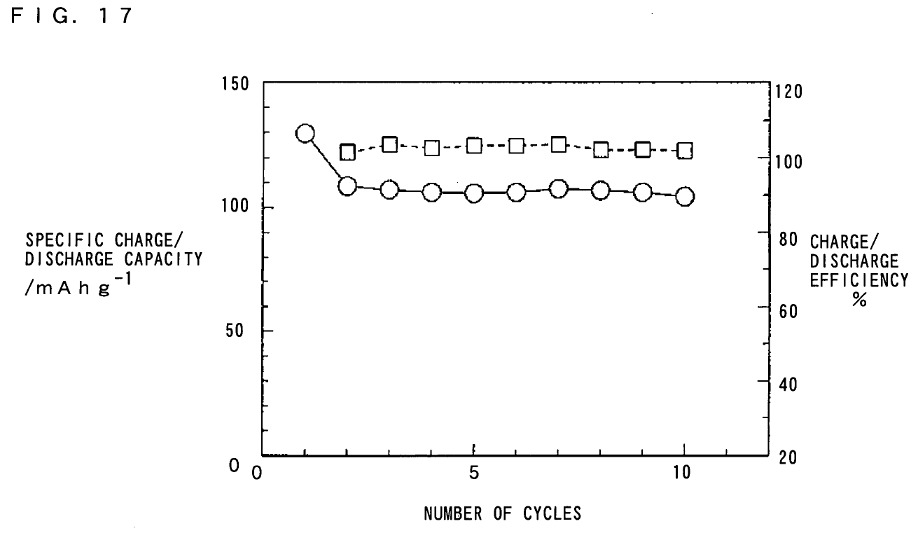

The test cell of the comparative example 4 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 17 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 10^{th} cycle was 102 mAh/g, whereas the capacity maintenance factor was 78.5%. The average charge/discharge efficiency proved to be 103%, approximately 100%.

The reason for the small capacity maintenance factor is probably that the electrode was not impregnated with the nonaqueous electrolyte, because the room temperature molten salt having high viscosity was used as the nonaqueous electrolyte. Considering that the test cell of the comparative example 4 exhibited the charge/discharge efficiency of approximately 100% as compared to that of the test cell in the comparative example 1, the use of a room temperature molten salt suppresses self-discharging.

### Comparative Example 5

A nonaqueous electrolyte according to the comparative example 5 was prepared as follows. Lithium bis(trifluoromethylsulfonyl)imide was added to trimethylpropylammoniumbis(trifluoromethylsulfonyl)imide, a room temperature molten salt, to give a concentration of 0.5 mol/l, and the resultant mixture was employed as the nonaqueous electrolyte. Otherwise, the test cell of the comparative example 5 was prepared similarly as in the inventive example 1.

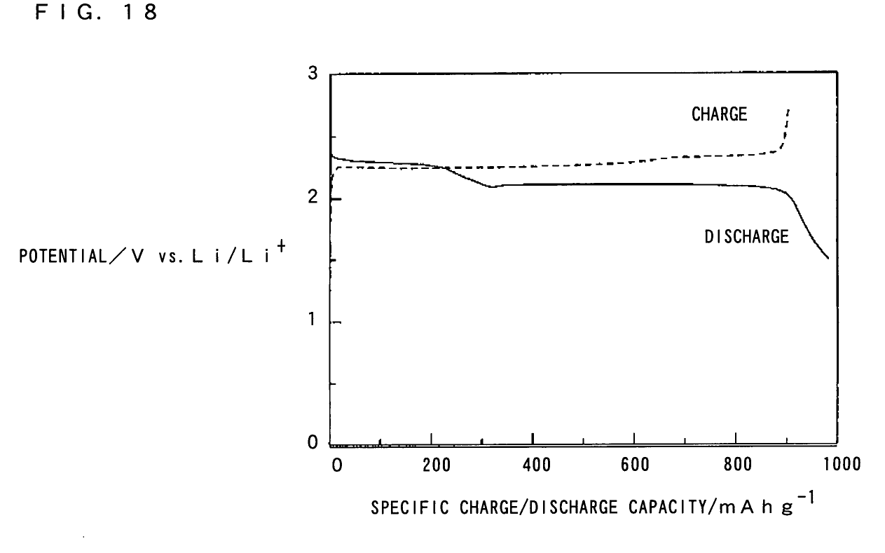

The test cell of the comparative example 5 was discharged to a discharge cutoff potential of 1.5V (vs. Li/Li⁺) at a discharge current of 0.05 mA/cm², and charged to a charge cutoff potential of 2.8 V (vs. Li/Li⁺) at a charge current of 0.05 mA/cm² to examine its charge/discharge characteristics. The results are given in FIG. 18.

The solid line indicates the discharge curve showing the relationship between potentials and capacities per 1 g electrode when discharged; and the broken line indicates the charge curve showing the relationship between potentials and capacities per 1 g electrode when charged. Note that “1 g electrode” refers to 1 g of the gross weight of the active material, conductive agent, binder, and thickener.

The results were that the initial specific discharge capacity was 981 mAh/g, and the subsequent specific charge capacity was 902 mAh/g.

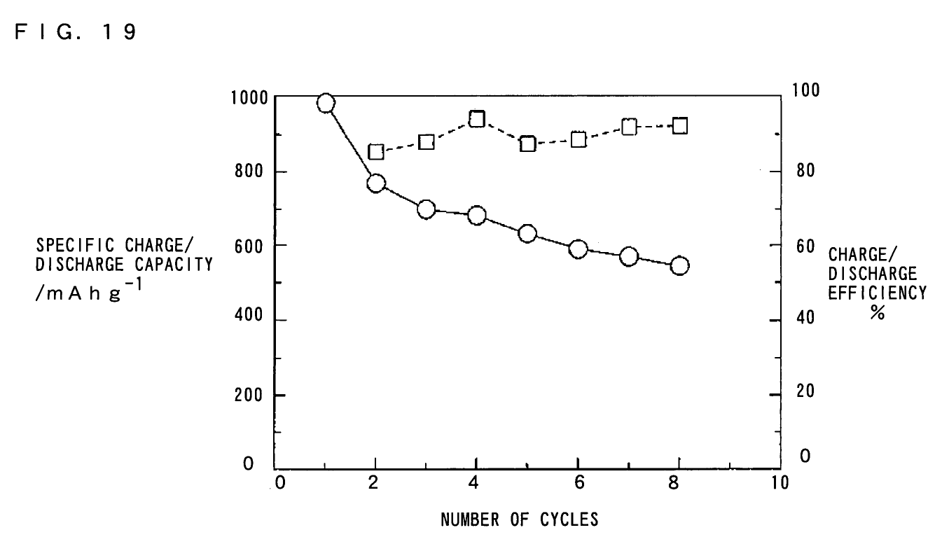

The test cell of the comparative example 5 was repeatedly discharged to the discharge cutoff potential of 1.5V (vs. Li/Li⁺) at the discharge current of 0.05 mA/cm², and then charged to the charge cutoff potential of 2.8 V (vs. Li/Li⁺) at the charge current of 0.05 mA/cm², to evaluate the specific charge capacity Qa (mAh/g) and the specific discharge capacity Qb (mAh/g) for each cycle, and also determine the charge/discharge efficiency (%) for each cycle using the above equation. FIG. 19 shows the specific discharge capacity (mAh/g) for each cycle indicated by the circle and solid line, and the charge/discharge efficiency (%) for each cycle indicated by the square and broken line.

Since the sulfur is oxidized, the cell was only discharged during the 1^{st} cycle, and the following charges and discharges were evaluated for charge/discharge efficiency starting from the 2^{nd} cycle. The charge/discharge efficiency for the 1^{st} cycle is thus not given. The specific discharge capacity after the 8^{th} cycle was 544 mAh/g, whereas the capacity maintenance factor was 55.4%. The average charge/discharge efficiency proved to be 89.6%.

While the initial specific discharge capacity was large and the average charge/discharge efficiency was relatively good, the capacity maintenance factor after the 8^{th} cycle was as low as 55.4%. This is probably because unlike the test cells in the inventive examples 2 to 4, the test cell of the comparative example 5 did not include lithium polysulfide saturated in the nonaqueous electrolyte.

### EVALUATION

Table 1 shows the nonaqueous electrolytes in the inventive examples 1 to 4 and the comparative examples 1 to 5; and Table 2 shows the measurements of cycle performance and charge/discharge characteristics in the inventive examples 1 to 4 and the comparative examples 1 to 5.

TABLE 1

| | | | | LITHIUM |
|---|---|---|---|---|
| | FIRST | SECOND | VOLUME | POLY- |
| | SOLVENT | SOLVENT | RATIO | SULFIDE |
| INVENTIVE | CYCLIC | ROOM | 10:90 | SATURATED |
| EXAMPLE 1 | ETHER | TEMPER- | | |
| | | ATURE | | |
| | | MOLTEN | | |
| | | SALT | | |
| INVENTIVE | CYCLIC | ROOM | 20:80 | SATURATED |
| EXAMPLE 2 | ETHER | TEMPER- | | |
| | | ATURE | | |
| | | MOLTEN | | |
| | | SALT | | |
| INVENTIVE | CYCLIC | ROOM | 30:70 | SATURATED |
| EXAMPLE 3 | ETHER | TEMPER- | | |
| | | ATURE | | |
| | | MOLTEN | | |
| | | SALT | | |
| INVENTIVE | CYCLIC | ROOM | 40:60 | SATURATED |
| EXAMPLE 4 | ETHER | TEMPER- | | |
| | | ATURE | | |
| | | MOLTEN | | |
| | | SALT | | |
| COMPAR- | CYCLIC | NONE | 100:0 | — |
| ATIVE | ETHER | | | |
| EXAMPLE 1 | | | | |
| COMPAR- | CYCLIC | ROOM | 80:20 | SATURATED |
| ATIVE | ETHER | TEMPER- | | |
| EXAMPLE 2 | | ATURE | | |
| | | MOLTEN | | |
| | | SALT | | |
| COMPAR- | CYCLIC | ROOM | 50:50 | SATURATED |
| ATIVE | ETHER | TEMPER- | | |
| EXAMPLE 3 | | ATURE | | |
| | | MOLTEN | | |
| | | SALT | | |
| COMPAR- | NONE | ROOM | 0:100 | SATURATED |
| ATIVE | | TEMPER- | | |
| EXAMPLE 4 | | ATURE | | |
| | | MOLTEN | | |
| | | SALT | | |
| COMPAR- | NONE | ROOM | 0:100 | — |
| ATIVE | | TEMPER- | | |
| EXAMPLE 5 | | ATURE | | |
| | | MOLTEN | | |
| | | SALT | | |

TABLE 2

| | | SPECIFIC CHARGE | | | | |
|---|---|---|---|---|---|---|
| | INITIAL SPECIFIC | CAPACITY (mAh/g) | SPECIFIC DISCHARGE | | CAPACITY | AVERAGE |
| | DISCHARGE CAPACITY | (CHARGE | CAPACITY (mAh/g) | | MAINTENANCE | CHARGE/ DISCHARGE |
| | (mAh/g) | CHARACTERISTICS) | (NUMBER OF CYCLES) | | FACTOR (%) | EFFICIENCY (%) |
| INVENTIVE | 515 | 530 | 500 | (28) | 97.1 | 99.5 |
| EXAMPLE 1 | | | | | | |
| INVENTIVE | 890 | 818 | 956 | (6) | 107 | 103 |
| EXAMPLE 2 | | | | | | |
| INVENTIVE | 1141 | 1134 | 1015 | (10) | 89.0 | 89.3 |
| EXAMPLE 3 | | | | | | |
| INVENTIVE | 816 | 908 | 834 | (8) | 102 | 85.6 |
| EXAMPLE 4 | | | | | | |
| COMPARATIVE | 538 | (DID NOT REACH | 352 | (6) | 65.4 | 64.3 |
| EXAMPLE 1 | | CUTOFF POTENTIAL) | | | | |
| COMPARATIVE | 605 | (DID NOT REACH | 981 | (11) | 162 | 69.0 |
| EXAMPLE 2 | | CUTOFF POTENTIAL) | | | | (2˜6) |
| | | 1290 (2˜6) | | | | 93.9 |
| | | 1000 (7˜) | | | | (7˜) |
| COMPARATIVE | 686 | 1000 | 820 | (5) | 120 | 84.2 |
| EXAMPLE 3 | | | | | | |
| COMPARATIVE | 130 | 107 | 102 | (10) | 78.5 | 103 |
| EXAMPLE 4 | | | | | | |
| COMPARATIVE | 981 | 902 | 544 | (8) | 55.4 | 89.6 |
| EXAMPLE 5 | | | | | | |

Of the test cells in the comparative examples 1, 2, 3 with the ratios of 4-methyl-1,3-dioxolane being large, the test cells in the comparative examples 1, 2 could not be charged to 2.8 V (vs. Li/Li⁺), because the self-discharge occurred during charge.

For the test cells in the comparative examples 2, 3, the self-discharge occurred prior to the tests, with the result that the initial specific discharge capacities were decreased.

For the test cell in the comparative example 4 which did not contain 4-methyl-1,3-dioxolane, however, it did not provide a large discharge capacity because of the large viscosity of its nonaqueous electrolyte.

For the test cell in the comparative example 5 which did not include saturated lithium polysulfide, the specific discharge capacity decreased with increasing number of cycles, resulting in a low capacity maintenance factor for the initial specific discharge capacity.

For the test cells in the inventive examples 1 to 4 with the ratios of the added 4-methyl-1,3-dioxolane being small, any phenomena as in the test cells of the comparative examples 1 to 4 were not observed, and the self-discharge reaction did not proceed during charge, resulting in large charge/discharge efficiencies. Moreover, self-discharge did not occur prior to the tests. Furthermore, the electrodes were impregnated with the nonaqueous electrolytes, so that large initial discharge capacities were achieved.

The foregoing reveal that it is more desirable to use trimethylpropylammoniumbis(trifluoromethylsulfonyl)imide, a room temperature molten salt, as a nonaqueous electrolyte than 4-methyl-1,3-dioxolane, for suppressing self-discharging and achieving a high charge/discharge efficiency. This, however, makes it difficult to impregnate the electrode with the nonaqueous electrolyte because of its high viscosity.

Attempts were thus made to lower the viscosity of the nonaqueous electrolyte by adding 4-methyl-1,3-dioxolane, and it was found that with the ratio of 4-methyl-1,3-dioxolane being large, 4-methyl-1,3-dioxolane becomes dominant in the properties of elemental sulfur. Therefore, the volume ratio of 4-methyl-1,3-dioxolane to trimethylpropylammonium bis(trifluoromethylsulfonyl)imide should be adjusted to the range of 0.1:99.9 to 40:60; preferably in the range of 0.1:99.9 to 30:70; more preferably in the range of 20:80.

It was also found that making lithium polysulfide saturated in the nonaqueous electrolyte beforehand avoids a large decrease in the specific discharge capacity, even with an increase in the number of cycles, unlike the case of the test cell in the comparative example 5. This results in a high value of the capacity maintenance factor for the initial specific discharge capacity.

Although the present invention has been described and illustrated in detail, it is clearly understood that the same is by way of illustration and example only and is not to be taken by way of limitation, the spirit and scope of the present invention being limited only by the terms of the appended claims.

1. A nonaqueous electrolyte secondary battery comprising:
a positive electrode including elemental sulfur;
a negative electrode including a material that can store lithium and release it; and
a nonaqueous electrolyte, wherein
said nonaqueous electrolyte contains a first solvent composed of at least one compound selected from the group consisting of cyclic ethers and chain ethers and a second solvent composed of a room temperature molten salt having a melting point not higher than 60° C. in a volume ratio in the range of 0.1:99.9 to 40:60, and also contains saturated lithium polysulfide.

2. The nonaqueous electrolyte secondary battery according to claim 1, wherein
said room temperature molten salt having a melting point not higher than 60° C. includes quaternary ammonium salts having melting points not higher than 60° C.

3. The nonaqueous electrolyte secondary battery according to claim 1, wherein
the volume ratio of said first solvent to said second solvent is in the range of 0.1:99.9 to 30:70.

4. The nonaqueous electrolyte secondary battery according to claim 1, wherein
the volume ratio of said first solvent to said second solvent is in the range of 0.1:99.9 to 20:80.

5. The nonaqueous electrolyte secondary battery according to claim 1, wherein
said second solvent includes trimethylpropylammonium bis(trifluoromethylsulfonyl)imide.

6. The nonaqueous electrolyte secondary battery according to claim 1, wherein
said first solvent includes 4-methyl-1,3-dioxolane.

7. The nonaqueous electrolyte secondary battery according to claim 1, wherein
said positive electrode further contains a conductive agent.

8. The nonaqueous electrolyte secondary battery according to claim 1, wherein
said material that can store lithium and release it includes at least one selected from the group consisting of lithium metal, lithium alloys, silicon, and carbon.
